(19) United States
(12) Patent Application Publication
(10) Pub. No.: US 2021/0229356 A1
(43) Pub. Date: Jul. 29, 2021

(54) BAFFLES TO ABSORB REFLECTED ENERGY IN REFLECTORS

(71) Applicant: HEWLETT-PACKARD DEVELOPMENT COMPANY, L.P., Spring, TX (US)

(72) Inventor: William WINTERS, Vancouver, WA (US)

(73) Assignee: Hewlett-Packard Development Company, L.P., Spring, TX (US)

(21) Appl. No.: 17/051,138

(22) PCT Filed: Oct. 12, 2018
(86) PCT No.: PCT/US2018/055696

§ 371 Date: Oct. 27, 2020

(51) Int. Cl. B29C 64/264; B33Y 30/00; B22F 12/40; B33Y 50/02; B22F 10/85; B29C 64/393; G01J 5/10; G02B 5/10

(52) U.S. Cl. CPC B29C 64/264; B33Y 30/00; B22F 12/40; B33Y 50/02; G01J 2005/0077; B29C 64/393; G01J 5/10; G02B 5/10; B22F 10/85

(57) ABSTRACT

According to examples, an apparatus may include a reflector having a parabolic shape, the reflector having a focal point and a plane of symmetry. The apparatus may also include a first energy emitter positioned at or near the focal point of the reflector, in which the reflector may reflect energy emitted from the first energy emitter in a first direction to a target area. The apparatus may further include a baffle extending along the plane of symmetry of the reflector, in which the baffle may absorb reflected energy directed to the baffle from the target area.

### BACKGROUND

In three-dimensional (3D) printing, an additive printing process may be used to make three-dimensional solid parts from a digital model. 3D printing may be used in rapid product prototyping, mold generation, mold master generation, and manufacturing. Some 3D printing techniques are considered additive processes because they involve the application of successive layers of material to an existing surface (template or previous layer). This is unlike traditional machining processes, which often rely upon the removal of material to create the final part. 3D printing may involve curing or fusing of the building material, which for some materials may be accomplished using heat-assisted melting, fusing, sintering, or otherwise coalescing, and then solidification, and for other materials may be performed through UV curing of polymer-based build materials or UV curable agents.

### BRIEF DESCRIPTION OF THE DRAWINGS

Features of the present disclosure are illustrated by way of example and not limited in the following figure(s), in which like numerals indicate like elements, in which:

FIG. 1A shows a front view, partially in cross section, of an example apparatus having a reflector, an energy emitter, and a baffle;

FIG. 1B shows a perspective view of the example apparatus and target area depicted in FIG. 1A;

FIG. 2 depicts a block diagram of an example apparatus having the reflector, the energy emitter, the baffle, a second energy emitter, and a controller;

FIG. 3 depicts a diagram of an example conditioning system that may be implemented in the apparatuses depicted in FIGS. 1A-2; and

FIG. 4 shows a diagram of an example apparatus that may have multiple reflectors, multiple energy emitters, and multiple baffles.

### DETAILED DESCRIPTION

Energy in the form or radiation, such as light, may be used in 3D printing processes to heat build material to cause the build material to be coalesced to form portions of 3D objects. That is, the energy may cause the build material to melt, fuse, cure, sinter, cause a reaction with another material, or otherwise coalesce prior to or as part of being joined. As used herein, the term “coalesced” may be defined as the build material being solidified following being melted, fused, cured, sintered, caused to have a reaction with another material, or otherwise joining together. In some 3D printing processes, the energy may be applied to coalesce build material positioned at selected locations. As such, the energy may not cause the build material outside of the selected locations to be coalesced. In one regard, the build material outside of the selected locations may not absorb the energy or may not absorb sufficient energy to be coalesced and instead, may reflect some of the energy applied onto that build material. The amount of energy reflected from the build material may be dependent upon patterns of a coalescing agent applied to the build material. For instance, a larger pattern of coalescing agent may result in a lesser amount of reflected energy from the build material.

Some 3D printing processes may utilize a reflector to direct and focus the energy from an energy source to the build material and the energy reflected from the build material may be directed back to the reflector. The energy reflected from the build material may be reflected in the reflector and the reflector may direct at least some of the reflected energy back onto the build material. As a result, the build material may receive energy at levels that may exceed intended levels, which may result in improper coalescing of the build material and/or fuse energy distribution ((or equivalently unintended thermal bleed) across the build material.

Disclosed herein are apparatuses for controlling the amount of energy applied to a target area of build material by blocking or reducing the re-emission of energy reflected from the target area back to the target area. The apparatuses disclosed herein may include a parabolic reflector that may direct energy from an energy emitter toward the target area. In addition, the apparatuses may include a baffle extending along a plane of symmetry of the parabolic reflector, in which the baffle may absorb energy that may be reflected back into the parabolic reflector from the target area. That is, the baffle may be positioned such that the baffle may absorb energy reflected back into the parabolic reflector and thus, may prevent the energy reflected from the target area from being directed back to the target area.

The baffle may become heated as the energy is absorbed and may emit heat that may be at a different wavelength than the absorbed energy. For instance, the energy emitter may emit energy having a first wavelength that is within the visible wavelength range and the baffle may emit energy having a second wavelength that is within the infrared wavelength range. As such, for instance, the amount of energy having a first wavelength that is within the visible wavelength range may be controlled without varying the energy emission from the energy emitter.

According to examples, the build material in the target area may absorb the energy having the second wavelength while at least some of the energy having the first wavelength may reflect off the build material. As such, the energy emitted from the baffle may raise the temperature of the build material, for instance, to a predefined temperature that may be lower than a melting temperature of the build material. In some examples, a second energy emitter may be provided on the baffle, in which the second energy emitter may emit energy at a wavelength that is within a wavelength range that the build material absorbs at a relatively high level. In addition, a controller may control the application of power, e.g., electricity, to the second energy emitter to vary the amount of energy emitted based on the amount of energy that the baffle has absorbed to control the amount of energy the build material absorbs. That is, the controller may control the application of power to the second energy emitter to cause the second energy emitter to compensate for the amount of energy that the baffle emits as a result of the absorbed energy.

Through implementation of the apparatuses disclosed herein, the amount of energy applied to build material that is to be coalesced together as well as the amount of energy applied to build material that is not to be coalesced together may be controlled. In addition, this control may be implemented without having to control an energy emitter that may output energy to coalesce the build material. In some instances, varying the energy emission of the energy emitter may not be possible and/or may not be preferable.

Before continuing, it is noted that as used herein, the terms “includes” and “including” mean, but is not limited to, “includes” or “including” and “includes at least” or “including at least.” The term “based on” means “based on” and “based at least in part on.”

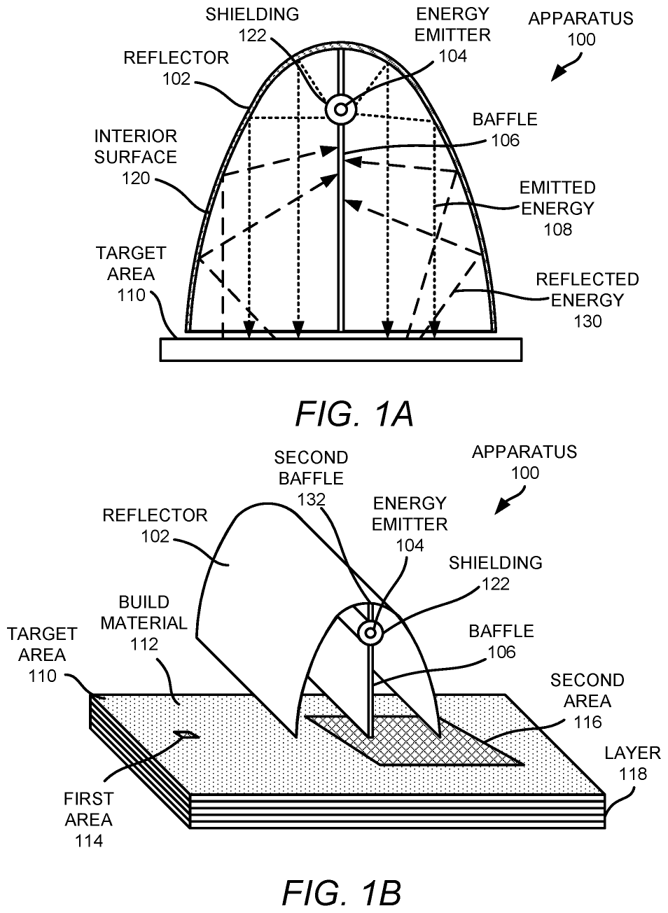

Reference is first made to FIGS. 1A and 1B. FIG. 1A shows a front view, partially in cross section, of an example apparatus 100 having a reflector 102, an energy emitter 104, and a baffle 106. FIG. 1B shows a perspective view of the example apparatus 100 and the target area 110 depicted in FIG. 1A. It should be understood that the example apparatus 100 depicted in FIGS. 1A and 1B may include additional components and that some of the components described herein may be removed and/or modified without departing from the scope of the example apparatus 100 disclosed herein.

Generally speaking, the apparatus 100 may be implemented to direct energy 108, or equivalently, radiation, emitted from the energy emitter 104 in the form of electromagnetic radiation, acoustic energy, or the like, onto a target area 110 while preventing or limiting energy reflected from the target area 110 from being directed back to the target area 110. That is, for instance, the apparatus 100 may operate as a one-way reflector of the energy 108 emitted by the energy emitter 104. The target area 110 may be, for instance, a layer of build material 112, in which the build material 112 positioned at selected areas of the layer are to be fused together through receipt of the emitted energy 108. In other examples, the target area 110 may be another type of material that is to be heated.

The apparatus 100 may be moved laterally across the target area 110 to direct the energy 108 onto different sections of the target area 110 as the apparatus 100 is moved with respect to the target area 110. In addition, or alternatively, the target area 110 may be provided on a movable bed (not shown) and the movable bed may be moved in X, Y, and/or Z directions with respect to the apparatus 100 to position different locations of the target area 110 in line with the apparatus 100.

The build material 112 may include any suitable material for forming a 3D object including, but not limited to, plastics, polymers, metals, nylons, and ceramics and may be in the form of a powder, a powder-like material, a fluid, a gel, or the like. References made herein to “powder” should also be interpreted as including “power-like” materials. Additionally, in instances in which the build material 112 is in the form of a powder, the build material 112 may be formed to have dimensions, e.g., widths, diameters, or the like, that are generally between about 5μm and about 100μm. In other examples, the build material 112 may have dimensions that may generally be between about 30μm and about 60μm. The build material 112 may generally have spherical shapes, for instance, as a result of surface energies of the particles in the build material and/or processes employed to fabricate the particles. The term “generally” may be defined as including that a majority of the particles in the build material 112 have the specified sizes and spherical shapes. In other examples, the term “generally” may be defined as a large percentage, e.g., around 80% or more of the particles have the specified sizes and spherical shapes. The build material 112 may additionally or alternatively include short fibers that may, for example, have been cut into short lengths from long strands or threads of material.

As shown in FIG. 1B, the target area 110 may include a first area 114 and a second area 116 at which the build material 112 in those areas are to be coalesced. By way of example, the build material 112 in the first area 114 and the second area 116 may be distinguished from the other areas of the target area 110 through selective application of a coalescing agent onto the first area 114 and the second area 116. The coalescing agent may be a substance that may act as a catalyst for determining whether application of energy results in the coalescing of the build material 112. The coalescing agent may be applied through use of a suitable coalescing agent applicator (not shown). In addition, the first area 114 and the second area 116 may be areas of the target area 110 layer that may be coalesced to form portions of a 3D object or portions of multiple 3D objects. As such, multiple layers 118 of the build material 112 may include selected areas of coalesced build material 112, such that the selectively coalesced build material 112 in the layers 118 may be coalesced to form the 3D object or objects.

According to examples, the coalescing agent may enhance absorption of energy from the apparatus 100 to heat the build material 112 to a temperature that is sufficient to cause the build material 112 upon which the coalescing agent has been deposited to melt, fuse, cure, sinter, cause a reaction with another material, or otherwise coalesce prior to or as part of being joined. In addition, the apparatus 100 may apply energy at a level (and/or a wavelength) that causes the build material 112 upon which the coalescing agent has been applied to be coalesced without causing the build material 112 upon which the coalesced agent has not been applied to be coalesced.

According to one example, a suitable coalescing agent may be an ink-type formulation including carbon black, such as, for example, the coalescing agent formulation commercially known as V1Q60A “HP fusing agent” available from HP Inc. In one example, such a coalescing agent may additionally include an infra-red light absorber. In one example, such an ink may additionally include a near infra-red light absorber. In one example, such a coalescing agent may additionally include a visible light absorber. In one example, such an ink may additionally include a UV light absorber. Examples of inks including visible light enhancers are dye-based colored ink and pigment-based colored ink, such as inks commercially known as CE039A and CE042A available from HP Inc. According to one example, a suitable detailing agent may be a formulation commercially known as V1Q61A “HP detailing agent” available from HP Inc. According to one example, a suitable build material may be PA12 build material commercially known as V1R10A “HP PA12” available from HP Inc. According to one example, the coalescing agent may be a low tint fusing agent (LTFA).

As shown in FIGS. 1A and 1B, the reflector 102 may include a parabolic shape having a focal point and a plane of symmetry and thus, the reflector 102 may be a parabolic reflector 102. The focal point of the reflector 102 may be the location at which the energy emitter 104 is positioned. In other words, the energy emitter 104 may be positioned at or near the focal point of the reflector 102 such that the reflector 102 may collimate the emitted energy 108 toward the target area 110. In addition, the plane of symmetry may be the plane along which the baffle 108 extends. In other words, the baffle 106 may extend along the plane of symmetry of the reflector 102. As a result, the baffle 106 may be aligned with the energy emitter 104 along the plane of symmetry of the reflector 102. The baffle 106 may also have a relatively thin profile such that the baffle 106 may limit blockage of the energy 108 directly emitted from the energy emitter 104 to the target area 110. The baffle 106 may also equivalently be referenced as a divider. As such references herein to the baffle 106 may equivalently apply to a divider.

The reflector 102 may include a mirrored or highly reflective interior surface 120 such that the energy 108 emitted from the energy emitter 104 and directed toward the interior surface 120 may be reflected from the interior surface 120. That is, the interior surface 120 may have a reflectance level that causes the interior surface 120 to reflect at least around 90% of the emitted energy 108. That is, for instance, the interior surface 120 may prevent less than around 10% loss or absorption of the emitted energy 108 that is directed to the interior surface 120. In other examples, the interior surface 120 may prevent a lower amount of energy loss or absorption, e.g., less than around 1% loss or absorption.

The reflector 102 may be formed of a metallic material, e.g., aluminum, silver, copper, or the like, a ceramic material, or the like, etc. The interior surface 120 may be formed of the same material as the reflector 102 or may be made of a different material. For instance, the outer section of the reflector 102 may be formed of a first type of metal and the interior surface 120 of the reflector 102 may be formed of a second type of metal. In any regard, the interior surface 120 may be polished and/or may undergo various processes to cause the interior surface 120 to have the reflectivity level discussed herein.

The energy emitter 104 may be a resistive energy emitter and may include resistive coils that emit the energy 108 as electricity is applied through the resistive coils. In some examples, the resistive coils may be encased in a shielding 122 to protect the coils in the energy emitter 104. The shielding 122 may be a transparent shielding 122, e.g., may be made of clear glass. In any regard, the energy 108 emitted from the energy emitter 104 may pass through the shielding 122 and may be directed in multiple directions out of the energy emitter 104. Some of the energy 108 may be emitted directly toward the target area 110 while some of the emitted energy 108 may be directed to the interior surface 120 of the reflector 102.

The interior surface 120 may reflect the emitted energy 108 that is directed to the interior surface 120 toward the target area 110 as shown in FIG. 1A. That is, the parabolic shape of the reflector 102 may cause the emitted energy 108 to be reflected in a manner such that the emitted energy 108 is directed onto the target area 110 in a collimated manner. As a result, the emitted energy 108 may be directed onto the target area 110 with a high level of intensity. That is, the emitted energy 108 at the target area 110 may have an intensity level that nearly matches, e.g., is within about 1%, of the intensity level of the energy 108 at the energy emitter 104.

According to examples, the build material 112 may be formed of light colored, e.g., white, powder or powder-like material. In addition, the energy emitter 104 may output energy at a first wavelength that the build material 112 may not absorb or may absorb at a relatively low level (e.g., at a sufficiently low level such that absorption of the energy may not cause the build material 112 to melt, fuse, sinter, etc. Instead, the first wavelength may be a wavelength that a coalescing agent applied on the build material 112 may absorb at a relatively high level (e.g., at a sufficiently high level to cause the build material 112 on which the coalescing agent has been applied to melt, fuse, sinter, etc. As a result, the build material 112 upon which the coalescing agent has not been applied may not absorb or may absorb an insufficient amount of the emitted energy 108 to cause the build material 112 to coalesce. However, the build material 112 on which the coalescing agent has been applied may become sufficiently heated to cause the build material 112 to coalesce.

As the build material 112 may not absorb or may absorb less than all of the emitted energy 108 applied onto the build material 112, the emitted energy 108 applied onto the build material 112 may reflect back toward the reflector 102. The reflected energy 130 is shown in FIG. 1A as dashed lines. As shown in FIG. 1A, the reflected energy 130 may be directed toward the apparatus 100. Some of the reflected energy 130 may be directed to the interior surface 120 and the interior surface 120 may cause the reflected energy 130 to be reflected in multiple directions. The interior surface 120 may cause the reflected energy 130 to be directed to the baffle 106. That is, the baffle 106 may extend along a plane of symmetry of the reflector 102 substantially from the shielding 122 to a bottom of the reflector 102. In other words, the baffle 106 may be sized and positioned to block and absorb a maximum amount of the reflected energy 130 inside the reflector 102. In some examples, the baffle 106 may extend a relatively shorter distance inside the reflector 102 and may absorb a lesser amount of energy.

In some examples, a second baffle 132 may be provided along the plane of symmetry to cover a space between the top of the shielding 122 and the reflector 102. The baffle 106 and the second baffle 132 may extend the majority of the height of the reflector 102 such that, for instance, most of the emitted energy 108 and the reflected energy 130 may not cross the plane of symmetry of the reflector 102. For instance, the baffle 106 and the second baffle 132 may block ray paths of radiation, e.g., the reflected energy 130, that enter the reflector 102 from exiting the reflector 102. The baffle 106 and the second baffle 132 may thus prevent at least some of the reflected energy 130 from being directed back to the target areal 110.

The baffle 106 and the second baffle 132 may be formed of a material and/or may have a color that may absorb the reflected energy 130, as well as the emitted energy 108, directed to the baffle 106. For instance, the baffle 106 and the second baffle 132 may be formed of and/or may include a black, light absorbing material that may withstand temperatures greater than around 2000 Kelvin, while in other examples, the baffle 106 may withstand higher or lower maximum temperatures. By way of particular example, the baffle 106 and the second baffle 132 may include and/or may be formed of an energy absorbing material that may remain intact while being subjected to temperatures above around 2700 Kelvin. As a result, when the reflected energy 130, as well as the emitted energy 108, is directed to and hits the baffle 106, the baffle 106 and the second baffle 132 may absorb all or most of that energy 130, 108. By way of particular example, the baffle 106 and the second baffle 132 may absorb greater than about 50% of the energy 130, 108 hitting the baffle 106. As other examples, the baffle 106 and the second baffle 132 may absorb greater than about 90% of the energy 130, 108 hitting the baffle 106 and the second baffle 132. In yet other examples, the baffle 106 and the second baffle 132 may absorb greater than about 95% of the energy 130, 108 hitting the baffle 106 and the second baffle 132. The baffle 106 and the second baffle 132 may be formed of, for instance, high temperature ceramic coated with a high emissivity, high temperature enamel, radio absorbing coatings, geometrically complex surface treatments that may absorb target energy, e.g., metamaterials, polymer, metal, ceramic foams, etc., or the like.

In instances in which the baffle 106 and the second baffle 132 are not present in the reflector 102, the reflected energy 130 may be reflected around the interior surface 120 of the reflector 102 until the energy 130 is absorbed by a material that may absorb the energy 130. That is, the interior surface 120 of the reflector 102 and the build material 112 may continue to reflect the reflected energy 130 until the reflected energy 130 hits coalescing agent applied in the target area 110. In instances in which a coalescing agent is applied onto a relatively small section of the target area 110, e.g., such as when the reflector 102 is positioned over the first area 114 shown in FIG. 1B, there may be a large amount of reflected energy 130. As such, the coalescing agent on the first area 114 may absorb a larger amount of energy 108, 130 than intended. As a result, the coalescing agent in the first area 114 and the build material 112 on which the coalescing agent is applied may be heated to a higher than intended temperature, which may cause the build material 112 in the first area 114 to coalesce improperly and thus, may cause defects in a 3D object fabricated from the build material 112.

However, in instances in which a coalescing agent is applied onto a relatively large section of target area 110, e.g., such as when the reflector 102 is positioned over the second area 116 shown in FIG. 1B, there may be less reflected energy 130 and the coalescing agent and the build material 112 in the second area 116 may be heated to or near the intended temperature. As a result, the build material 112 in the second area 116 may be coalesced as intended and may result in the formation of a 3D object having fewer or no defects.

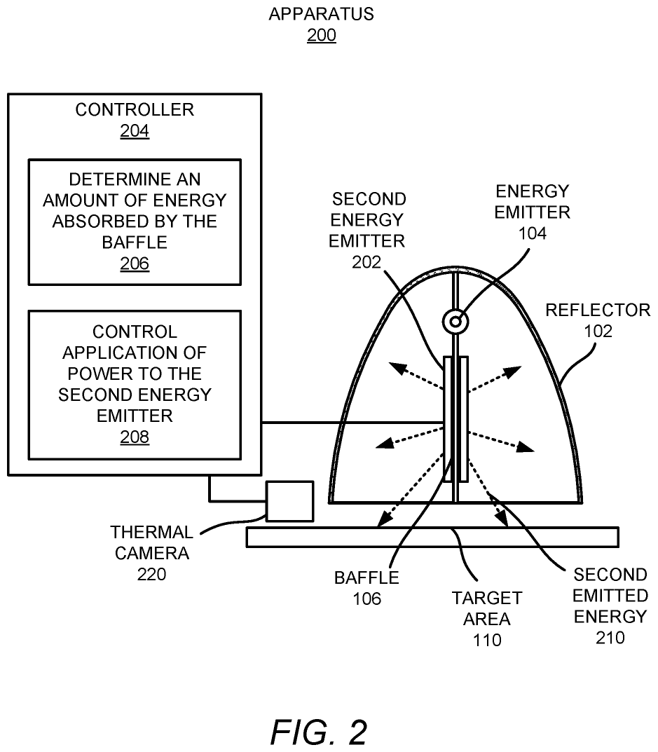

Turning now to FIG. 2, there is shown a block diagram of an example apparatus 200 having the reflector 102, the energy emitter 104, the baffle 106, a second energy emitter 202, and a controller 204. It should be understood that the example apparatus 200 depicted in FIG. 2 may include additional components and that some of the components described herein may be removed and/or modified without departing from the scope of the example apparatus 200 disclosed herein. The second energy emitter 202 may also equivalently be referenced herein as a radiation emitter.

As shown, the second energy emitter 202 may be positioned inside the reflector 102 and the controller 204 may control the second energy emitter 202. For instance, the second energy emitter 202 may be attached to the baffle 106 in various manners as discussed in detail herein. In addition, the second energy emitter 202 may be a resistive energy emitter and may include resistive coils that may emit a second energy 210 as electricity is applied through the resistive coils. The second energy 210 may have a different wavelength than the wavelength of the energy emitted 108 by the energy emitter 104. The second energy 210 may be emitted to condition, e.g., warm, the build material 112 and thus, the second energy 210 may have a wavelength that the build material 112 may absorb at a relatively high level as discussed herein. For instance, the second energy 210 may be in the infrared wavelength range while the first energy 108 may be in the visible wavelength range. That is, for instance, the build material 112 may have a white or other light color and thus, the build material 112 may absorb the second energy 210 while reflecting the first energy 108.

According to examples, the second energy 210 may be emitted onto the build material 112 to increase and/or maintain the temperature of the build material 112 at or near a predefined temperature and/or within a predefined temperature range. The predefined temperature and/or the predefined temperature range may be a temperature and/or a temperature range that is within a certain temperature difference from a melting point temperature of the build material 112. The certain temperature difference may be a temperature difference that may correspond to an increase in temperature of the build material 112 that may occur when the coalescing agent absorbs the energy 108. That is, the certain temperature difference may be sufficiently small to cause the build material 112 on which the coalescing agent has been deposited to at least partially melt, sinter, cure, or the like, when the coalescing agent absorbs the first energy 108.

Generally speaking, as the baffle 106 absorbs the reflected energy 130, the baffle 106 may become heated and may emit energy, e.g., in the infrared wavelength. The heat emitted from the baffle 106 may also be applied onto the build material 112 in the target area 110 to raise the temperature of the build material 112. In some instances, e.g., when the reflector 102 is positioned to heat a portion of the target area 110 having a small area of coalescing agent, the baffle 106 may absorb a relatively large amount of reflected energy 130 and may thus have an elevated temperature, which may be emitted back to the build material 112, e.g., as second energy 210. In other instances, e.g., when the reflector 102 is positioned to heat a portion of the target area 110 having a larger area of coalescing agent, the baffle 106 may absorb a relatively small amount of reflected energy 130 and may thus have a relatively lower temperature. As such, the amount of heating applied onto the build material 112 by the baffle 106 may vary depending on, for instance, the coverage of coalescing agent on the build material 112 in the target area 110.

According to examples, the controller 204 may control the amount of second energy 210 that the second energy emitter 202 emits based upon a determined amount of energy that the baffle 106 emits. As the amount of energy that the baffle 106 emits is based on the amount of energy that the baffle 106 absorbs, the controller 204 may determine 206 an amount of energy that the baffle 106 absorbed. The controller 204 may make this determination in any of a number of manners. For instance, the controller 204 may determine the coverage of the coalescing agent on the build material 112 over which the reflector 102 is currently positioned. The controller 204 may make this determination based upon, for instance, a data file of the object being fabricated, in which the data file may identify the locations in the target area 110 at which coalescing agent is to be applied.

By way of example, the controller 204 may determine the percentage of the build material 112 over which the reflector 102 is currently positioned that has been provided with the coalescing agent. Based on the determined percentage, the controller 204 may calculate the amount of reflected energy 130 that the baffle 106 has likely absorbed. For instance, the relationships between the coalescing agent coverage percentages and the amount of reflected energy 130 absorption may be determined through testing, modeling, etc., and may be stored in a data store (not shown), e.g., in a lookup table. The controller 204 may access the lookup table to calculate the amount of reflected energy 130 that the baffle 106 has likely absorbed.

As shown in FIG. 2, the apparatus 200 may include a thermal camera 220 that may capture a thermal image of portions of the target area 110. That is, the thermal camera 220 may capture an image that identifies temperatures across a portion, across multiple portions, or across the entire target area 110. Based on the temperatures identified in the thermal image, the controller 204 may determine the amount of energy likely absorbed by the baffle 106. That is, the relationships between the temperatures shown in thermal images and the amount of reflected energy 130 absorption by the baffle 106 may be determined through testing, modeling, etc., and may be stored in a data store (not shown), e.g., in a lookup table. The controller 204 may access the lookup table to calculate the amount of reflected energy 130 that the baffle 106 has likely absorbed. In addition, or alternatively, the controller 204 may use a closed loop control system, such as a proportional, integral, derivative system, in conjunction with the thermal camera 220 to achieve desired thermal conditions in the target area 110.

According to examples, the amount of second energy 210 that the second energy emitter 202 emits may be controlled based on the amount of power (or equivalently, electricity, voltage, current, etc.) applied to the second energy emitter 202. Thus, the second energy emitter 202 may emit a greater amount of second energy 210 when a greater amount of power is applied to the second energy emitter 202. In these examples, the controller 204 may also control 208 application of power to the second energy emitter 202 to vary the amount of second energy 210 that the second energy emitter 202 emits. Particularly, for instance, the controller 204 may control 208 application of power based on the determined 206 amount of energy 130 absorbed by the baffle 106. By way of example, the controller 204 may control application of power to the second energy emitter 202 to cause the second energy emitter 202 to emit second energy 210 at a level that, along with the second energy 210 emitted by the baffle 106, may raise or maintain the temperature of the build material 112 at or near the predefined temperature and/or within the predefined temperature range discussed herein.

Thus, in instances in which a determination is made that the baffle 106 has absorbed a greater amount of energy 130, the controller 204 may cause power to be applied at a relatively lower level. In contrast, in instances in which a determination is made that the baffle 106 has absorbed a lower amount of energy 130, the controller 204 may cause power to be applied a relatively higher level. In examples, the relationships between the amount of reflected energy 130 absorbed and the amount of power applied may be determined through testing, modeling, etc., and may be stored in a data store (not shown), e.g., in a lookup table. The controller 204 may access the lookup table to determine the amount of power to be applied to the second energy emitter 202 based on the determined amount of energy that the baffle 106 has likely absorbed.

The controller 204 may be an integrated circuit, such as an application-specific integrated circuit (ASIC). In these examples, the instructions 206 and 208 may be programmed into the integrated circuit. In other examples, the controller 204 may operate with firmware (i.e., machine-readable instructions) stored in a memory. In these examples, the controller 204 may be a microprocessor, a CPU, or the like. In these examples, the instructions 206 and 208 may be firmware and/or software that the controller 204 may execute as discussed in detail herein.

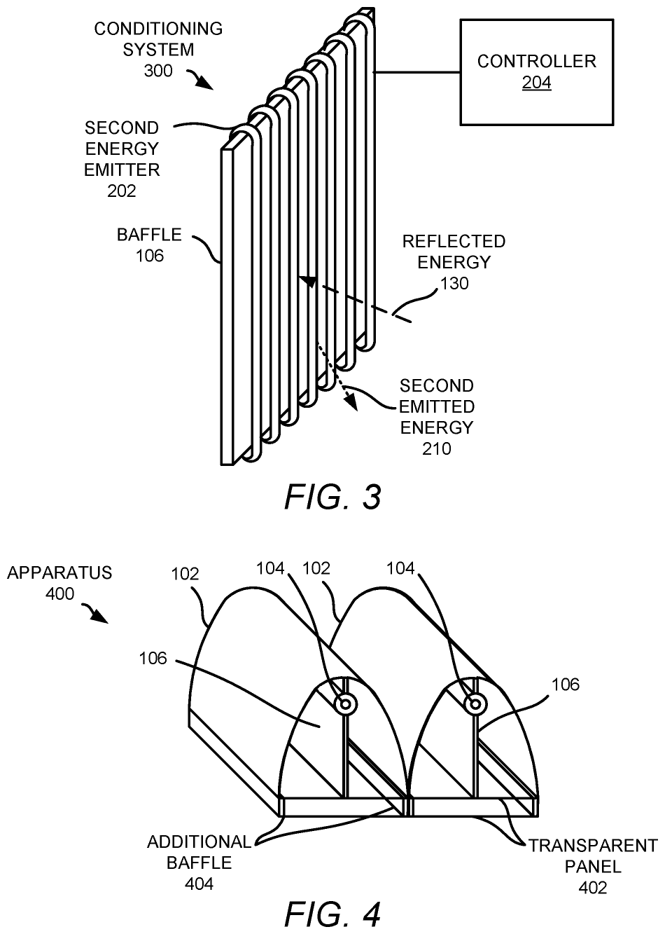

Turning now to FIG. 3, there is shown a diagram of an example conditioning system 300 that may be implemented in the apparatuses 100, 200 depicted in FIGS. 1A-2. It should be understood that the example conditioning system 300 depicted in FIG. 3 may include additional components and that some of the components described herein may be removed and/or modified without departing from the scope of the example conditioning system 300 disclosed herein.

As shown, the second energy emitter 202 may be formed of a coil of electrically resistive material and may wrap around portions of the baffle 106. In addition, gaps may be provided between portions of the second energy emitter 202 to enable reflected energy 130 to hit the baffle 106 and for the baffle 106 to absorb the reflected energy 130 as discussed herein. As also discussed herein, the controller 204 may control the second energy emitter 202 to emit second energy 210 in addition to the energy that the baffle 106 may emit from absorbing the reflected energy 130.

With reference now to FIG. 4, there is shown a diagram of an example apparatus 400 that may have multiple reflectors 102, multiple energy emitters 104, and multiple baffles 106. It should be understood that the example apparatus 400 depicted in FIG. 4 may include additional components and that some of the components described herein may be removed and/or modified without departing from the scope of the example apparatus 400 disclosed herein.

As shown, the apparatus 400 may include similar components as those depicted in FIGS. 1A-3 and thus the components are not described again with respect to FIG. 4. The apparatus 400 may differ from the apparatus 100 in that the apparatus 400 may include multiple apparatuses 100. In addition, the apparatus 400 may include multiple transparent panels 402 to separate the interiors of the reflectors 102 from the build material 112 as well as debris that may be introduced into the interiors of the reflectors 102. The transparent panels 402 may be formed of a glass that may withstand the temperatures generated by the energy emitters 104. The apparatus 400 may further include additional baffles 404 that may be positioned between the transparent panels 402 to, for instance, further block the reflected energy 130 from being redirected back onto the build material 112 in the target area 110.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a reflector having a parabolic shape, the reflector having a focal point and a plane of symmetry;
a first energy emitter positioned at or near the focal point of the reflector, the reflector to reflect energy emitted from the first energy emitter in a first direction to a target area; and
a baffle extending along the plane of symmetry of the reflector, the baffle to absorb reflected energy directed to the baffle from the target area.

2. The apparatus of claim 1, wherein the reflector has a first end and a second end, the focal point being closer to the first end than the second end, and wherein the baffle extends from the energy emitter to the second end.

3. The apparatus of claim 2, further comprising:
a second baffle extending along the plane of symmetry of the reflector between the first energy emitter toward the first end.

4. The apparatus of claim 1, wherein the baffle has a dark color to absorb the energy.

5. The apparatus of claim 1, further comprising:
a second energy emitter attached to the baffle, wherein the second energy emitter is be controlled to selectively emit a second energy, the second energy having a different wavelength than the energy emitted by the first energy emitter.

6. The apparatus of claim 5, further comprising:
a controller to:
determine an amount of energy absorbed by the baffle; and
control application of power to the second energy emitter to selectively emit the second energy based on the determined amount of energy absorbed by the baffle.

7. The apparatus of claim 6, further comprising:
a thermal camera to detect a temperature of the target area;
wherein the controller is to determine the amount of energy absorbed by the baffle from the determined temperature of the target area.

8. A system comprising:
an apparatus having a reflector, the reflector having a parabolic shape;
a first radiation emitter positioned at or near a focal point of the reflector, the reflector to reflect first radiation emitted from the first radiation emitter in a first direction to selectively fuse build material upon which a coalescing agent has been applied; and
a divider extending along a center of the reflector, the divider to block ray paths of radiation that enter the reflector from exiting the reflector.

9. The system of claim 8, wherein the first radiation has a first wavelength tuned for absorption by the coalescing agent and for reflection from the build material.

10. The system of claim 8, further comprising:
a second radiation emitter provided on the divider, the second radiation emitter to selectively emit a second radiation having a second wavelength tuned for absorption by the build material.

11. The system of claim 10, further comprising:
a controller to determine an amount of first radiation absorbed by the divider and to control supply of power to the second radiation emitter based on the determined amount of first radiation absorbed by the divider.

12. The system of claim 11, further comprising:
a controller to:
determine a temperature of a layer of build material;
determine the amount of first radiation absorbed by the divider based on the determined temperature of the layer of build material.

13. An apparatus comprising:
a parabolic reflector;
a divider extending along a plane of symmetry of the parabolic reflector;
an energy emitter to emit energy onto an interior surface of the parabolic reflector, the parabolic reflector to direct the first energy toward a target area; and
a radiation emitter to emit radiation onto the target area, the radiation emitter provided on the divider.

14. The apparatus of claim 13, wherein the energy emitter is to emit energy having a first wavelength and wherein the radiation emitter is to emit radiation having a second wavelength.

15. The apparatus of claim 14, wherein the first wavelength is in a visible wavelength range and the second wavelength is in the infrared wavelength range.
